(19) United States
(12) Patent Application Publication
(10) Pub. No.: US 2026/0331113 A1
(43) Pub. Date: Oct. 22, 2026

(54) LOW BITRATE SCENE-BASED AUDIO CODING

(71) Applicant: DOLBY LABORATORIES LICENSING CORPORATION

(72) Inventors: Stefanie Brown, Lewisham, NSW (AU); Rishabh RishabhTyagi, Sydney, NSW (AU)

(73) Assignee: DOLBY LABORATORIES LICENSING CORPORATION, (US)

(21) Appl. No.: 19/119,362

(22) PCT Filed: Sep. 29, 2023
(86) PCT No.: PCT/US2023/075621

§ 371 Date: Apr. 8, 2025

Related U.S. Application Data
(60) Provisional application No. 63/421,045, filed on Oct. 31, 2022.
(60) Provisional application No. 63/582,950, filed on Sep. 15, 2023.

(51) Int. Cl. G10L 19/008; G10L 19/032

(52) U.S. Cl. CPC G10L 19/008; G10L 19/032

(57) ABSTRACT

Enclosed are embodiments for very low bit rate scene-based audio (LBRSBA) coding with combined SPAR and DIRAC. In some embodiments, a method comprises: receiving scene based audio metadata; creating from the scene based audio metadata, Spatial Reconstruction (SPAR) metadata and Directional Audio Coding (DirAC) metadata; forming a group of SPAR metadata bands and a group of DirAC metadata bands; quantizing the group of SPAR metadata bands and the group of DirAC metadata bands; and sending to a decoder a first data frame including the quantized group of DirAC metadata bands and a first portion of the quantized group of SPAR metadata bands, and a second data frame following the first data frame, the second data frame including the quantized DirAC metadata bands and a second portion of the quantized group of SPAR metadata bands.

### CROSS REFERENCE TO RELATED APPLICATIONS

This application claims priority to U.S. provisional application 63/421,045, filed 31 Oct. 2022 and U.S. provisional application 63/582,950 filed 15 Sep. 2023, all of which are incorporated herein by reference in their entirety.

### TECHNICAL FIELD

This disclosure relates generally to audio processing.

### BACKGROUND

Spatial Reconstruction (SPAR) and Directional Audio Coding (DirAC) are separate spatial audio coding technologies that each seek to represent an input spatial audio scene in a compact way to enable transmission with a good trade-off between audio quality and bitrate. One such input format for a spatial audio scene is a scene-based audio representation (e.g., first-order Ambisonics (FOA) or higher-order Ambisonics (HOA)).

SPAR seeks to maximize perceived audio quality while minimizing bitrate by reducing the energy of the transmitted audio data while still allowing the second-order statistics of the Ambisonics audio scene (i.e., the covariance) to be reconstructed at the decoder side using transmitted metadata. SPAR seeks to faithfully reconstruct the input Ambisonics scene at the output of the decoder.

DirAC is a technology which represents spatial audio scenes as a collection of directions of arrival (DOA) in time-frequency tiles. From this representation, a similar-sounding scene can be reproduced in a different output format (e.g., binaural). Notably, in the context of Ambisonics, the DirAC representation allows a decoder to produce higher-order output from low-order input. DirAC seeks to preserve direction and diffuseness of the dominant sounds in the input scene.

Both DirAC and SPAR have different strengths and properties. It is therefore desirable to combine the complementary aspects of DirAC and SPAR (e.g., higher audio quality, reduced bitrate, input/output format flexibility and/or reduced computational complexity) into a coder/decoder (“codec”), such as an Ambisonics codec.

### SUMMARY

Enclosed are embodiments for low bitrate scene-based audio (LBRSBA) coding using SPAR and DirAC.

In some embodiments, a method of audio metadata encoding comprises: receiving, with at least one processor, scene-based audio metadata; creating, with the at least one processor and from the scene-based audio metadata, Spatial Reconstruction (SPAR) metadata and Directional Audio Coding (DirAC) metadata; forming, with the at least one processor, a group of SPAR metadata bands and a group of DirAC metadata bands; quantizing, with the at least one processor, the group of SPAR metadata bands and the group of DirAC metadata bands; and sending to a decoder: a first data frame including the quantized group of DirAC metadata bands and a first portion of the quantized group of SPAR metadata bands, and a second data frame following the first data frame, the second data frame including the quantized DirAC metadata bands and a second portion of the quantized group of SPAR metadata bands.

In some embodiments, the method further comprises sending to the decoder a signal indicating the first data frame or the second data frame.

In some embodiments, the group of SPAR metadata bands includes four SPAR metadata bands and the group of DirAC bands includes two DirAC metadata bands, and where the group of SPAR bands are lower in frequency then the group of DirAC bands.

In some embodiments, the group of DirAC metadata bands is sent to the decoder at a first time resolution and the first and second portions of the group of SPAR metadata bands are sent to the decoder at a second time resolution, wherein the second time resolution is lower than the first time resolution.

In some embodiments, the group of DirAC metadata bands is sent to the decoder at the first time resolution when the first data frame is an initial data frame or the group of DirAC metadata bands is encoded within a metadata bitrate budget.

In some embodiments, the group of SPAR metadata bands is sent to the decoder at the second time resolution when the group of SPAR metadata bands is not encoded within the metadata bitrate budget.

In some embodiments, the method further comprises prior to receiving the scene-based audio metadata, applying, with the at least one processor, smoothing to a covariance matrix from which scene-based audio metadata is formed.

In some embodiments, the covariance smoothing uses a smoothing factor that increases smoothing at low frequency bands and avoids modifying an amount of smoothing in high frequency bands.

In some embodiments, the smoothing factor is given by the function: smoothing_factor(b)=update_factor(b)/min_pool_size*k* (b+1), where update_factor(b) is the number of frequency bins in frequency band b, min_pool_size is the minimum number of frequency bins desired, and k is a factor that increases or decreases smoothing.

In some embodiments, a method of audio metadata decoding comprises: receiving, with at least one processor, quantized scene-based audio data and corresponding metadata, the metadata including decorrelator coefficients; dequantizing, with the at least one processor, the quantized scene-based audio data and corresponding metadata; decoding, with the at least one processor, the scene-based audio data and corresponding metadata, the decoding including recovering the decorrelator coefficients; smoothing, with the at least one processor, the decorrelator coefficients; and reconstructing, with the at least one processor, a multichannel audio signal based on at least the decoded scene-based audio data and the smoothed decorrelator coefficients.

Other embodiments disclosed herein are directed to a system, apparatus and computer-readable medium. The details of the disclosed embodiments are set forth in the accompanying drawings and the description below. Other features, objects and advantages are apparent from the description, drawings and claims.

Particular embodiments disclosed herein combine the complementary aspects of DirAC and SPAR technologies into a single codec that provides high audio quality at low bitrates for scene-based audio (e.g., Ambisonics).

### DESCRIPTION OF DRAWINGS

FIG. 1 is a block diagram of an IVAS codec framework, according to one or more embodiments.

FIG. 2 is a flow diagram of covariance smoothing process, according to one or more embodiments.

FIG. 3 is a flow diagram of an example modification to the process shown in FIG. 2 for a maximum permitted forgetting factor, according to one or more embodiments.

FIG. 4 is a flow diagram of an example modification to transient detection process flow, according to one or more embodiments.

FIG. 5 is a plot of decorrelation coefficients over n frames, according to one or more embodiments.

FIG. 6 is a flow diagram of LBRSBA (e.g., Ambisonics) processing, according to one or more embodiments.

FIG. 7 is a block diagram of an example hardware architecture suitable for implementing the systems and methods described in reference to FIGS. 1-6.

In the drawings, specific arrangements or orderings of schematic elements, such as those representing devices, units, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some implementations.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

The same reference symbol used in various drawings indicates like elements.

### DETAILED DESCRIPTION

In the following detailed description, numerous specific details are set forth to provide a thorough understanding of the various described embodiments. It will be apparent to one of ordinary skill in the art that the various described implementations may be practiced without these specific details. In other instances, well-known methods, procedures, components, and circuits, have not been described in detail so as not to unnecessarily obscure aspects of the embodiments. Several features are described hereafter that can each be used independently of one another or with any combination of other features.

### Nomenclature

As used herein, the term “includes,” and its variants are to be read as open-ended terms that mean “includes but is not limited to.” The term “or” is to be read as “and/or” unless the context clearly indicates otherwise. The term “based on” is to be read as “based at least in part on.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting or deriving. In addition, in the following description and claims, unless defined otherwise, all technical and scientific terms used herein have the same meaning as commonly understood by one of ordinary skills in the art to which this disclosure belongs.

### Example IVAS Codec Framework

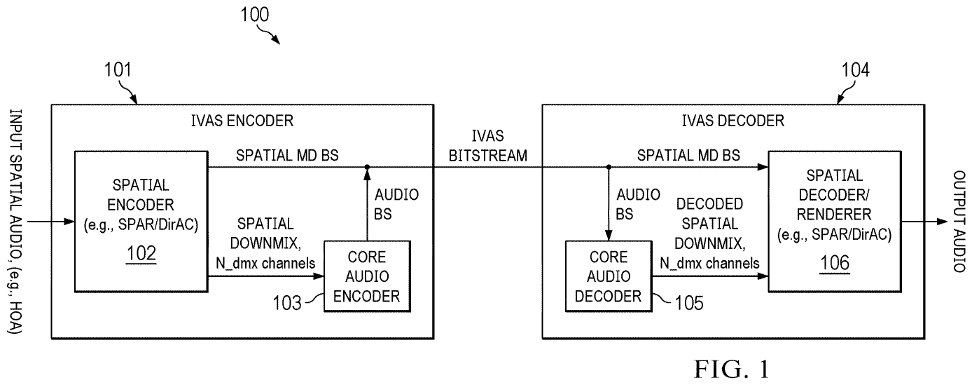

FIG. 1 is a block diagram of an immersive voice and audio services (IVAS) coder/decoder (“codec”) framework 100 for encoding and decoding WAS bitstreams, according to one or more embodiments. WAS is expected to support a range of audio service capabilities, including but not limited to mono to stereo upmixing and fully immersive audio encoding, decoding and rendering. IVAS is also intended to be supported by a wide range of devices, endpoints, and network nodes, including but not limited to: mobile and smart phones, electronic tablets, personal computers, conference phones, conference rooms, virtual reality (VR) and augmented reality (AR) devices, home theatre devices, and other suitable devices.

IVAS codec 100 includes IVAS encoder 101 and IVAS decoder 104. IVAS encoder 101 includes spatial encoder 102 that receives N channels of input spatial audio (e.g., FOA, HOA). In some implementations, spatial encoder 102 implements SPAR and DirAC for analyzing/downmixing N_dmx spatial audio channels, as described in further detail below. The output of spatial encoder 102 includes a spatial metadata (MD) bitstream (BS) and N_dmx channels of spatial downmix. The spatial MD is quantized and entropy coded. In some implementations, quantization can include fine, moderate, coarse and extra coarse quantization strategies and entropy coding can include Huffman or Arithmetic coding. In some implementations, the spatial encoder permits not more than 3 levels of quantization at a given operating mode; however, with decreasing bitrates, the three levels become increasingly coarser overall, to meet bitrate requirements. Core audio encoder 103 (e.g., Single Channel Element (SCE) encoding unit encodes N_dmx channels (N_dmx=1-16 channels) of the spatial downmix into an audio bitstream, which is combined with the spatial MD bitstream into an IVAS encoded bitstream transmitted to IVAS decoder 104. For LBRSBA, given the bitrate constraints, the number of spatial downmix channels will be limited to 1.

IVAS decoder 104 includes core audio decoder 105 (e.g., Single Channel Element (SCE)) that decodes the audio bitstream extracted from the IVAS bitstream to recover the N_dmx audio channels. Spatial decoder/renderer 106 (e.g., SPAR/DirAC) decodes the spatial MD bitstream extracted from the IVAS bitstream to recover the spatial MD and synthesizes/renders output audio channels using the spatial MD and a spatial upmix for playback on various audio systems with different speaker configurations and capabilities.

### Low Bitrate SBA (LBRSBA)

In some embodiments, it is desirable to implement LBRSBA (e.g., Ambisonics) using a SPAR-DIRAC codec. LBRSBA can be achieved using one or more of the following techniques: 1) reduced MD bitrate and band interleaving; 2) extra covariance smoothing to facilitate the reduced MD bitrate; and 3) decoder side decorrelator coefficient smoothing.

Background information for the above techniques can be found in one or more of the following documents:
PCT Application No. 2023/063769, for “DirAC-SPAR Audio Processing”;
U.S. Pat. No. 9,978,385 for “Parametric reconstruction of audio signals”;
International Application No. WO20212252748A1, for “Encoding of multi-channel audio signals comprising downmixing of a primary and two or more scaled non-primary input channels”;
International Application No. WO2022120093A1, for “Immersive Voice and Audio Services (IVAS) with Adaptive Downmix Strategies”;
International Application No. WO2021252811A2, for “Quantization and Entropy Coding of Parameters for a Low Latency Immersive Audio Codec”;
US Patent Publication No. 20220406318A1, for “Bitrate Distribution in Immersive Voice and Audio Services”; and
US Patent Publication No. 2022/0277757 for “Systems and Methods for Covariance Smoothing.”

### I. Reduced Metadata Bitrate and Band Interleaving

When implementing LBRSBA (e.g., below 24.4 kbps), tradeoffs need to be made between the limitations of spatial metadata bitrate and quality, and core codec bitrate and audio quality. In some embodiments, low bitrate is achieved by operating with fewer frequency bands (e.g., 6 bands instead of 12 bands) to reduce the amount of spatial metadata that is transported from the encoder to the decoder. In one particular embodiment, the bottom 4 bands (4 lower frequency bands) are allocated to SPAR and the top 2 bands (2 higher frequency bands) are allocated to DirAC.

Table I below illustrates example band allocation when going from 12 bands to 6 bands in a particular embodiment:

TABLE I
Example Band Allocations

| | SPAR Bands | | | | | | | | DirAC Bands | | | |
|---|---|---|---|---|---|---|---|---|---|---|---|---|
| Non- | 0 | 1 | 2 | 3 | 4 | 5 | 6 | 7 | 8 | 9 | 10 | 11 |
| LBRSBA | | | | | | | | | | | | |
| banding | | | | | | | | | | | | |
| (not to scale) | | | | | | | | | | | | |
| Reduced | 0 | | 1 | | 2 | | 3 | | 4 | | 5 | |
| LBRSBA | | | | | | | | | | | | |
| banding | | | | | | | | | | | | |
| 20 ms MD | Y | | Y | | Y | | Y | | Y | | Y | |
| update/initial | | | | | | | | | | | | |
| frame | | | | | | | | | | | | |
| 40 ms MD | A | | B | | A | | B | | Y | | Y | |
| update | | | | | | | | | | | | |

Y—All DirAC and SPAR bands sent every frame
A/B—Half of the SPAR bands sent in alternating A/B frames

As shown in Table I, the SPAR bands (bands 0-7) are reduced to a LBRSBA band group with four bands (bands 0-3) and DirAC bands (8-11) are reduced to a LBRSBA band group with two bands (bands 4 and 5) for a total of 6 LBRSBA bands. The time-resolution of the metadata is also reduced. At higher bitrates, DirAC metadata is often calculated at a 5 ms resolution while SPAR metadata is calculated at a 20 ms resolution. Accordingly, at LBRSBA, a slower update rate of metadata is used. In particular, SPAR metadata moves to a 40 ms update rate, with occasional 20 ms updates, where permissible by bitrate limitations. The DirAC metadata bitrate remains at 20 ms resolution, (compared to a DirAC baseline), or is dropped from 5 ms to 20 ms compared to the higher bitrates used in non-LBRSBA operation. In some embodiments, only SPAR MD is reduced to band groups. In some embodiments, more or fewer SPAR or DirAC bands can be grouped together and/or there can be more than two groups of bands.

In some embodiments, for initial frames or frames where the metadata is coded within the metadata bitrate budget, all SPAR and DirAC bands are sent to the decoder in the frame. In cases where the metadata bitrate budget cannot be met, a first portion (e.g., a first half) of the group of SPAR metadata bands is sent in in a first data frame, followed by a second data frame that includes a second portion (e.g., a second half) of the group of SPAR metadata bands, and so on. In some embodiment, the choice of which bands to send or omit in each frame is interleaved. For example, when band metadata is omitted for a frame, it is assumed to be the same metadata as that band for the previous frame. The advantage of this interleaving approach is that more frames are generated with (relatively) finely quantized metadata, at the cost of time resolution. This significantly reduces the metadata bitrate, leaving more bits for the core coder.

In some embodiments, an indication of what type of frame has been coded, (all-bands, A data frame or B data frame) is achieved by reusing existing SPAR metadata bitstream signaling for time differential coding of metadata.

Table II below lists example coding schemes for non-LBRSBA and LBRSBA coding:

TABLE II
Examples of Non-LBRSBA and LBRSBA Coding Schemes

| Coding scheme name | Non-LBRSBA-Description | LBRSBA-Description |
|---|---|---|
| BASE | Non-time differential | Non-time differential |
| | arithmetic coding of all | arithmetic coding of all |
| | bands. | bands. |
| BASE_NOEC | Non-time differential non- | Non-time differential non- |
| | entropy coding of all bands. | entropy coding of all bands. |
| FOUR_A | ¼ available bands are coded | 40 ms MD: Arithmetic coding |
| | in the clear, and ¾ in time- | of only the A bands. |
| | differential; with a pattern of | |
| | 1000 . . . repeated over the | |
| | available bands. | |
| FOUR_B | Time-differential coding with a | 40 ms MD: Arithmetic coding |
| | pattern of 0 1 0 0 . . . repeated | of only the B bands. |
| FOUR_C | Time-differential coding with a | 40 ms MD: Arithmetic coding |
| | pattern of 0 0 1 0 . . . repeated | of only the A bands. |
| FOUR_D | Time-differential coding with a | 40 ms MD: Arithmetic coding |
| | pattern of 0 0 0 1 . . . repeated | of only the B bands. |

Referring to Table II above, BASE indicates entropy coding using an arithmetic coder. FOUR_X indicates time differential coding of some bands using the original arithmetic, and a time-differential arithmetic coder. In some embodiments, a Huffman coder is used.

In an A frame or B frame, the metadata for unsent bands is held at that band's value from the previous frame where it was sent. In the case of packet loss, the best-case recovery is one frame, if BASE or BASE_NOEC frame is used in the subsequent frame, or two frames (a successive A and B frame), otherwise.

Table III below lists examples of IVAS SBA (Ambisonics) bitrates including LBRSBA bitrates.

| | Available | | |
|---|---|---|---|
| | IVAS | | |
| | SBA | | |
| | bitrates | | |
| | (kbps) | N_dmx | SPAR Active/Passive W |
| LBRSBA | 13.2 | 1 | LBRSBA modified Active W |
| (SPAR + DirAC | 16.4 | | (DTX tuning), 40 ms MD |
| extension) | | | |
| Non-LBRSBA | 24.4 | | Non-LBRSBA active W tuning |
| Bitrates for | 32 | | |
| SPAR + DirAC | 48 | 2 | Passive W |
| | 64 | | |
| | 80 | | |
| | 96 | 3 | |
| | 128 | 4 | |
| | 160 | | |
| | 192 | | |
| | 256 | | |
| | 384 | | |
| | 512 | | |

### II. Covariance Smoothing

In some embodiments, extra covariance smoothing is applied to the LBRSBA covariance matrix to further reduce the SPAR metadata bitrate and improve single channel element (SCE) core decisions (e.g., ACELP/TCX) used to code the spatial downmix channel. Covariance smoothing is described in US Patent Publication No. 2022/0277757 for “Systems and methods for covariance smoothing,” but the smoothing factor has been modified for LBRSBA as described below. Smoothing is applied to the covariance matrix before the MD is received or computed. In some embodiments, a frequency-domain representation of the audio is used to generate the covariance matrix which is smoothed using the covariance smoothing technique described below. After covariance smoothing, the SPAR and DirAC metadata are formed using the smoothed covariance matrix, grouped into LBRSBA bands as shown in Table I, quantized and sent to the decoder.

i. Smoothing Function and Forgetting Factor

Covariance smoothing utilizes a smoothed matrix. Generally, a smoothed matrix can be calculated using a low-pass filter designed to meet particular smoothing requirements. In some embodiments, the smoothing requirements are such that previous estimates are used to artificially increase the number of frequency samples (bins) used to generate the current estimate of a covariance matrix. In some embodiments, calculating the smoothed matrix A from an input covariance matrix A over a frame sequence uses a first order auto-regressive low pass filter that uses a weighted sum of past and present frames' estimated matrix values:

Ã[n]=Ã[n−1]+λ(A[n]−Ã[n−1]), [1]

where λ is a forgetting factor, or an update rate, i.e., how much emphasis is placed on previous estimation data and n is the frame number. In some embodiments, this only has meaning for the frames after the first frame, as there is no value for A [0]. In some embodiments, A[0] is given the value of 0, resulting in a smoothing of A[1]. In some embodiments, A[0] is given the value of A[1], resulting in no smoothing of A[1].

Equation [1] is one example of a smoothing function that is a first order low pass filter. Other smoothing functions can also be used, such as a higher order filter. The important factors of the smoothing function are the looking-back aspect of using previously smoothed results and the forgetting factor to give weight to the influence of those results. The effect of the forgetting factor is that, as the smoothing is applied over successive frames, the effect of previous frames becomes less and less impactful on the smoothing of the frame being smoothed (adjusted). When the forgetting factor in the Equation [1] is one (λ=1), no smoothing occurs, and it effectively acts as an all-pass filter. When 0<λ<1 the equation acts as a low pass filter. The lower λ places more emphasis on the old covariance data, while a higher λ takes more of the new covariance into account. A forgetting factor over one (e.g., 1<λ<2) implements as a high pass filter.

In some embodiments, a maximum permissible forgetting factor λₘₐₓ is implemented. This maximum value will determine the behavior of the algorithm once the bins/band values become large. In some embodiments, λₘₐₓ<1 will always implement some smoothing in every band, regardless of what the calculated forgetting factor is; and λₘₐₓ=1 will only apply the smoothing function to bands with less bins than the desired Nₘᵢₙ, leaving larger bands unsmoothed.

In some of those embodiments, the forgetting factor for a particular band λ_{b} is calculated as the minimum of the maximum permitted forgetting factor λₘₐₓ and the ratio of the effective number of bins in the band N_{b} and the minimum number of bins Nₘᵢₙ that are determined to give a good statistical estimate based on the window size:

$${λ}_{b} = min ( {λ}_{max} , \frac{{N}_{b}}{{N}_{min}} ) . \qquad [ 2 ]$$

In some embodiments N_{b} is the actual count of bins for the frequency band. In some embodiments, N_{b} can be calculated from the sum of a particular band's frequency response, e.g. if a band's response is r=[0.5, 1, 1, 0.5, 0, . . . , 0], the effective number of bins N_{b}=sum(r)=0.5+1+1+0.5=3. In some embodiments, λₘₐₓ=1 such that λ_{b} stays within a reasonable range, e.g., 0<λ_{b}<1. This means that smoothing is applied proportionally to small sample estimates, and no smoothing is applied at all to large sample estimates. In some embodiments, λₘₐₓ<1 which forces larger bands to be smoothed to a certain extent regardless of their size (e.g., λₘₐₓ=0.9). In some embodiments, Nₘᵢₙ can be selected based on the data at hand that produces the best subjective results. In some embodiments, Nₘᵢₙ can be selected based on how much initial (first subsequent frame after the initial frame of a given window) smoothing is desired.

In an example, using an analysis filterbank with narrower (i.e. fewer bins, more frames needed for good statistical analysis) low-frequency bands and wider (i.e. more bins, less frames needed for good statistical analysis) high-frequency bands, this would have the effect of increasing the amount of smoothing in lower frequency bands and decreasing the amount (or not smoothing at all if λₘₐₓ=1) in higher frequency bands.

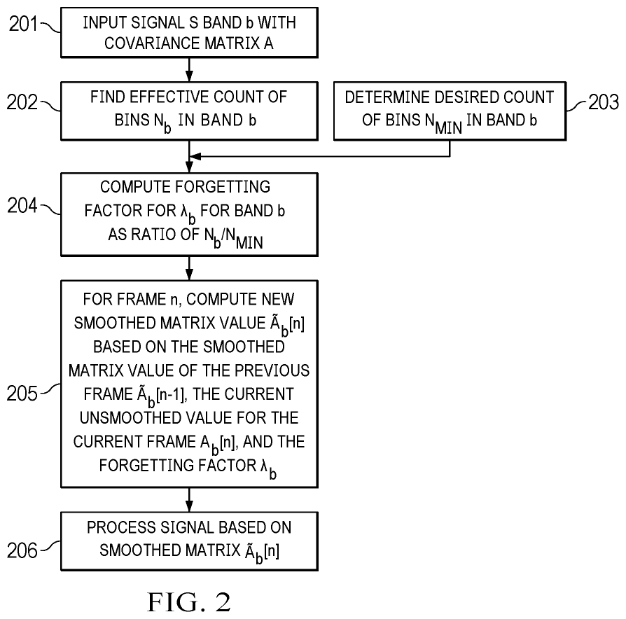

FIG. 2 is a flow diagram of a covariance smoothing process, according to one or more embodiments. An input frequency-domain signal (e.g., Fast Fourier transform (FFT)) 201 provides for a given band in an input signal a corresponding covariance matrix over a window. An effective count of the bins for that band is taken 202. This can be, for example, calculated by the filterbank response values of the band. A desired bin count is determined 203, for example by a subjective analysis of how many bins would be needed to provide a good statistical analysis for the window. A forgetting factor is computed 204 by taking a ratio of the calculated number of bins to the desired bin count. For a given frame (other than the first frame), a new covariance matrix value is computed 205 based on the new covariance value computed for the previous frame, the original value for the current frame, and the forgetting factor. The new (smoothed) matrix formed by these new values is used in further signal processing 206.

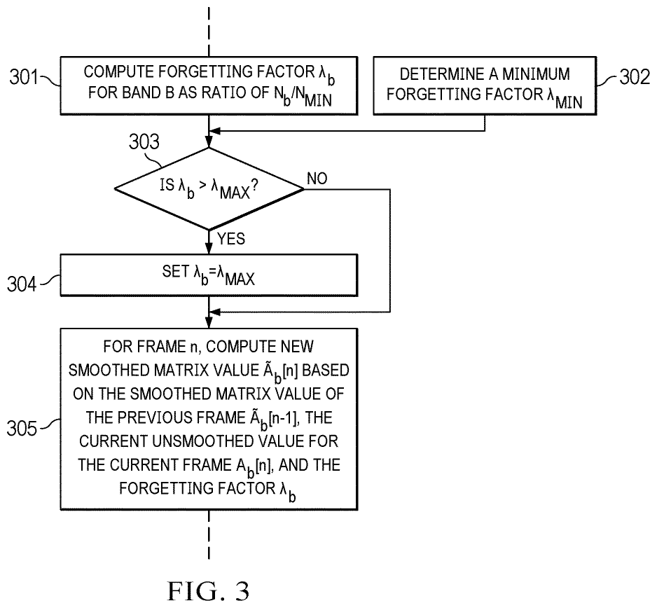

FIG. 3 shows an example modification to process 200 for a maximum permitted forgetting factor, according to one or more embodiments. As shown in FIG. 2, a forgetting factor is computed 301 for the band. Additionally, a maximum permitted forgetting factor is determined 302. The values are compared 303, and in response to the calculated factor being less than the maximum permitted factor, then the calculated factor is used in the smoothing 305 (hereinafter, “smoothing_factor”). If the calculated factor is greater than the maximum permitted factor, the maximum permitted factor is used 304 in the smoothing 305. The example shows the calculated factor being used if the factors are equal (not greater than), but an equivalent flow can be envisioned where the minimum value is used if they are equal.

In some embodiments, the smoothing factor is different depending on whether the codec is operating at non-LBRSBA or LBRSBA. The non-LBRSBA smoothing factor is given by:

smoothing_factor(b)=update_factor(b)/min_pool_size=number of bins in frequency band b/minimum number of bins desired. [3]

The LBRSBA smoothing factor is given by:

smoothing_factor(b)=update_factor(b)/min_pool_size*k*(b+1), [4]

where the example factor k=0.75, at non-LBRSBAs to increase/decrease smoothing at low frequency bands while avoiding smoothing of higher bands.

The smoothing of the covariance matrix is then performed in accordance with the principles related to Equation [1]. For LBRSBA, k is set to 0.5, to further increase smoothing at the lowest bands (e.g., SPAR bands), while avoiding modifying smoothing at higher bands (e.g., DirAC bands). Other embodiments may use other values for k.

ii. Smoothing Reset

In some embodiments, there may be a desire to avoid smoothing over transients (sudden changes in signal level) as this may produce unwanted signal distortion/artifacts in the output. In these embodiments, the smoothing can be “reset” at points where transients are detected in the signal. The previous time frame's estimated smoothing matrix can be stored to facilitate calculation of the smoothed value for the current frame. If a transient is detected in the input signals during that frame, the smoothing function can be set to re-initialize itself. When a transient is detected, the past matrix estimate is reset to the current estimate, such that the output of the smoothing filter after a transient is the estimate itself (no change applied). In other words, for the reset frame Ã_{b}[n]=A_{b}[n]. After the reset frame, subsequent frames can have the smoothing function applied again until the next reset.

iii. Transient Detection

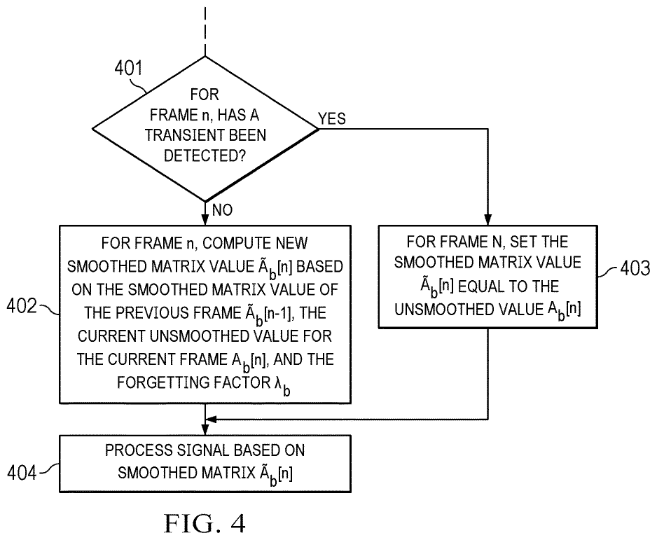

FIG. 4 is a flow diagram of a process for modifying the transient detection process flow, according to one or more embodiments. A determination is made 401 if a transient is detected for a given frame. If it is 403, then the new matrix value remains the same as the input value. If not 402, the usual smoothing algorithm is used for that frame. The combination (matrix) of smoothed and non-smoothed (transient) frame values are used for signal processing 404.

In some embodiments, the smoothing is reset when a transient is detected on any channel. For example, if there are N channels, N transient detectors can be used (one per channel) and if any of them detect a transient, the smoothing is reset or end of signal or end of smoothing (smoothing is turned off). For the example of a stereo input, the channels may be determined to be distinct (or possibly distinct) enough such that only considering transients in the left channel might mean an important transient in the right channel may be improperly smoothed (and vice versa). Therefore, two transient detectors are used (left and right) and either one of these can trigger a smoothing reset of the entire 2×2 matrix.

In some embodiments, the smoothing is only reset on transients for certain channels. For example, if there are N channels, only M (<N, possibly 1) detectors are used. For the example of a First Order Ambisonics (FOA) input, the first (W) channel can be determined to be the most important compared to the other three (X, Y, Z) and, given the spatial relationships between FOA signals, transients in the latter three channels will likely be reflected in the W channel anyway. Therefore, the system can be set up with a transient detector only on the W channel, triggering a reset of the entire 4×4 covariance smoothing matrix when it detects a transient on W.

In some embodiments, the reset only resets covariance elements that have experienced the transient. This would mean that a transient in the n^{th} channel would only reset values in the n^{th} row and in the n^{th} column of the covariance matrix (entire row and entire column). This can be performed by having separate transient monitoring on each channel and a detected transient on any given channel would trigger a reset for matrix positions that correspond to that channel's covariance to another channel (and vice versa, and, trivially, to itself).

In some embodiments, the reset only occurs on a majority/threshold number of channels detecting a transient. For example, in a four-channel system, the threshold could be set to trigger a reset only if at least two of the channels report a transient in the same frame. In some embodiments, band-selective covariance smoothing resetting is implemented. While covariance smoothing resetting functionality helps to allow the covariance to move quickly in cases where transients occur, in cases where some bands are heavily smoothed, e.g., at lowest frequencies, rapid repeated detected transients and subsequent resetting of the covariance smoothing sometimes creates an audible stuttering effect. By selectively resetting bands with less smoothing, this effect can be minimized/avoided.

### III. Decorrelator Smoothing

Due to the relatively coarse quantization of decorrelator parameters required to meet metadata bitrate targets, quantization error often manifests as too much decorrelation, or flicking between significant and insignificant (e.g., large and small or none) amounts of decorrelation. In some embodiments, decoder side decorrelator coefficient smoothing can help to prevent this effect from being audible. Many forms of smoothing are possible, but in this embodiment, the smoothing is mathematically equivalent to what is used for covariance smoothing described above, except without the ability to reset smoothing on transients. In some embodiments, a forgetting factor of 0.5 can be used for all bands, though other values are also possible.

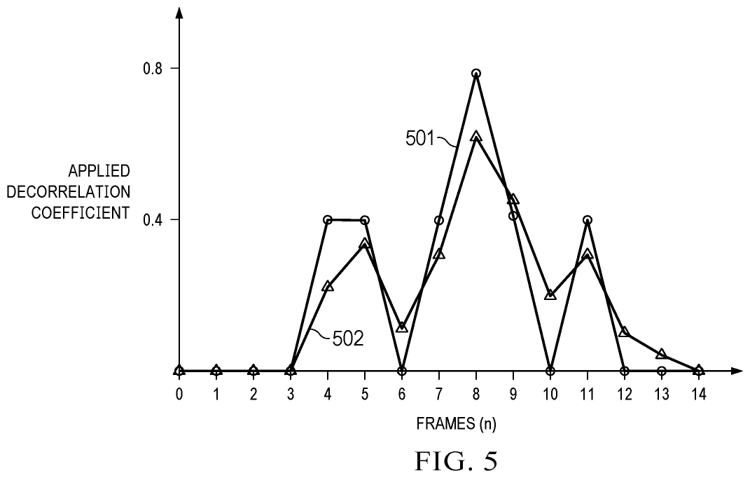

FIG. 5 are plots of smoothed and unsmoothed quantized decorrelation coefficients over n frames, according to one or more embodiments. A first plot 501 shows an example of unsmoothed quantized decorrelation coefficients at the decoder with three possible levels (0.0. 0.4, 0.8). A second plot 502 shows an example of smoothed quantized decorrelator coefficients.

### Example Processes

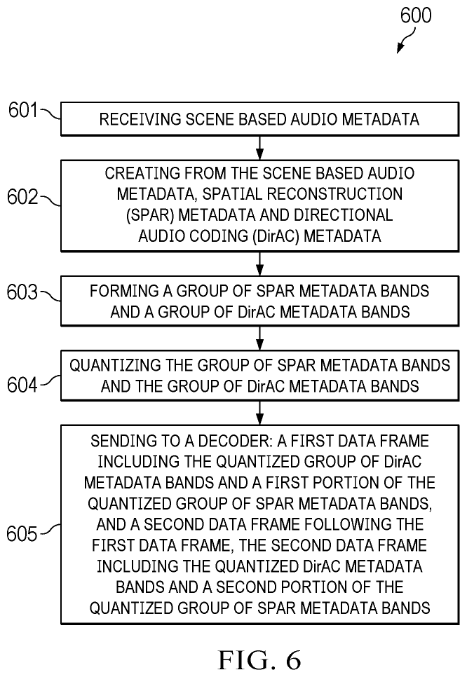

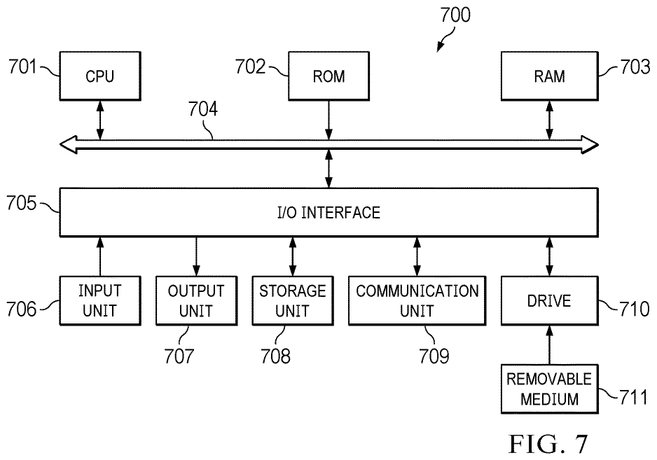

FIG. 6 is a flow diagram of LBRSBA Ambisonics processing, according to one or more embodiments. Process 600 can be implemented using the electronic device architecture described in reference to FIG. 7. In some embodiments, process 600 includes: receiving scene based audio metadata (601); creating from the scene based audio metadata, Spatial Reconstruction (SPAR) metadata and Directional Audio Coding (DirAC) metadata (602); forming a group of SPAR metadata bands and a group of DirAC metadata bands (603); quantizing the group of SPAR metadata bands and the group of DirAC metadata bands (604); sending to a decoder: a first data frame including the quantized group of DirAC metadata bands and a first portion of the quantized group of SPAR metadata bands, and a second data frame following the first data frame, the second data frame including the quantized DirAC metadata bands and a second portion of the quantized group of SPAR metadata bands (605).

Each of these steps were described more fully above.

### Example System Architecture

FIG. 7 shows a block diagram of an example electronic device architecture 700 suitable for implementing example embodiments of the present disclosure. Architecture 700 includes but is not limited to servers and client devices, as previously described in reference to FIGS. 1-6. As shown, the architecture 700 includes central processing unit (CPU) 701 which is capable of performing various processes in accordance with a program stored in, for example, read only memory (ROM) 702 or a program loaded from, for example, storage unit 708 to random access memory (RAM) 703. In RAM 703, the data required when CPU 701 performs the various processes is also stored, as required. CPU 701, ROM 702 and RAM 703 are connected to one another via bus 804. Input/output (I/O) interface 705 is also connected to bus 704.

The following components are connected to I/O interface 705: input unit 706, that may include a keyboard, a mouse, or the like; output unit 707 that may include a display such as a liquid crystal display (LCD) and one or more speakers; storage unit 708 including a hard disk, or another suitable storage device; and communication unit 709 including a network interface card such as a network card (e.g., wired or wireless).

In some implementations, input unit 706 includes one or more microphones in different positions (depending on the host device) enabling capture of audio signals in various formats (e.g., mono, stereo, spatial, immersive, and other suitable formats).

In some implementations, output unit 707 include systems with various number of speakers. Output unit 707 (depending on the capabilities of the host device) can render audio signals in various formats (e.g., mono, stereo, immersive, binaural, and other suitable formats).

In some embodiments, communication unit 709 is configured to communicate with other devices (e.g., via a network). Drive 710 is also connected to I/O interface 705, as required. Removable medium 711, such as a magnetic disk, an optical disk, a magneto-optical disk, a flash drive or another suitable removable medium is mounted on drive 710, so that a computer program read therefrom is installed into storage unit 708, as required. A person skilled in the art would understand that although system 700 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 709, and/or installed from the removable medium 711, as shown in FIG. 7.

Generally, various example embodiments of the present disclosure may be implemented in hardware or special purpose circuits (e.g., control circuitry), software, logic or any combination thereof. For example, the units discussed above can be executed by control circuitry (e.g., CPU 701 in combination with other components of FIG. 7), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

While this document contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method of audio metadata encoding, comprising:
receiving, with at least one processor, scene-based audio metadata;
creating, with the at least one processor and from the scene-based audio metadata, Spatial Reconstruction (SPAR) metadata and Directional Audio Coding (DirAC) metadata;
forming, with the at least one processor, a group of SPAR metadata bands and a group of DirAC metadata bands;
quantizing, with the at least one processor, the group of SPAR metadata bands and the group of DirAC metadata bands; and
sending to a decoder:
a first data frame including the quantized group of DirAC metadata bands and a first portion of the quantized group of SPAR metadata bands, and
a second data frame following the first data frame, the second data frame including the quantized DirAC metadata bands and a second portion of the quantized group of SPAR metadata bands.

2. The method of claim 1, further comprising sending to the decoder a signal indicating the first data frame or the second data frame.

3. The method of claim 1, wherein the group of SPAR metadata bands includes four SPAR metadata bands and the group of DirAC bands includes two DirAC metadata bands, and where the group of SPAR bands are lower in frequency then the group of DirAC bands.

4. The method of claim 1, wherein the group of DirAC metadata bands is sent to the decoder at a first time resolution and the first and second portions of the group of SPAR metadata bands are sent to the decoder at a second time resolution, wherein the second time resolution is lower than the first time resolution.

5. The method of claim 4, wherein the group of DirAC metadata bands is sent to the decoder at the first time resolution when the first data frame is an initial data frame or the group of DirAC metadata bands is encoded within a metadata bitrate budget.

6. The method of claim 4, wherein the group of SPAR metadata bands is sent to the decoder at the second time resolution when the group of SPAR metadata bands is not encoded within the metadata bitrate budget.

7. The method of claim 1, further comprising:
prior to receiving the scene-based audio metadata, applying, with the at least one processor, smoothing to a covariance matrix from which scene-based audio metadata is formed.

8. The method of claim 7, wherein the covariance smoothing uses a smoothing factor that increases smoothing at low frequency bands and avoids modifying an amount of smoothing in high frequency bands.

9. The method of claim 7, wherein the smoothing factor is given by the function:
smoothing_factor(b)=update_factor(bymin_pool_size*k*(b+1),
where update_factor(b) is the number of frequency bins in frequency band b, min_pool_size is the minimum number of frequency bins desired, and k is a factor that increases or decreases smoothing.

10. A method of audio metadata decoding, comprising:
receiving, with at least one processor, quantized scene-based audio data and corresponding metadata, the metadata including decorrelator coefficients;
dequantizing, with the at least one processor, the quantized scene-based audio data and corresponding metadata;
decoding, with the at least one processor, the scene-based audio data and corresponding metadata, the decoding including recovering the decorrelator coefficients;
smoothing, with the at least one processor, the decorrelator coefficients; and
reconstructing, with the at least one processor, a multichannel audio signal based on at least the decoded scene-based audio data and the smoothed decorrelator coefficients.

11. An encoder device, comprising:
at least one processor; and
memory storing instructions, that when executed by the at least one processor, cause the computing apparatus to perform the method recited in claim 1.

12. A non-transitory computer-readable medium storing instructions that, when executed by at least one processor, cause the at least one processor to perform operations of claim 1.

13. A decoder device, comprising:
at least one processor; and
memory storing instructions, that when executed by the at least one processor, cause the computing apparatus to perform the method recited in claim 10.

14. A non-transitory computer-readable medium storing instructions that, when executed by at least one processor, cause the at least one processor to perform operations of claim 10.
